(19) United States
(12) Patent Application Publication
(10) Pub. No.: US 2008/0288297 A1
(43) Pub. Date: Nov. 20, 2008

(54) Hedged financial product having a guaranteed minimum withdrawal benefit and method of generating the same

(76) Inventor: Samson Koo, Scarsdale, NY (US)

Correspondence Address: AMSTER, ROTHSTEIN & EBENSTEIN LLP, 90 PARK AVENUE, NEW YORK, NY, 10016, US

(21) Appl. No.: 11/803,592

(22) Filed: May 14, 2007

(51) Int. Cl. G06Q 40/00

(52) U.S. Cl. 705/4; 705/35

(57) ABSTRACT

A method for generating a hedged financial product having a guaranteed minimum withdrawal benefit including the steps of: formulating a financial product having a guaranteed minimum withdrawal benefit which is defined by a payout calculated based on a function of an investment value of an underlying asset, the investment value being tied to a benchmark that changes based on a first algorithm; and hedging a risk associated with the guaranteed minimum withdrawal benefit by investing funds in one or more assets in accordance with a second algorithm which is a function of the first algorithm.

### FIELD OF THE INVENTION

This application is directed to hedged financial products, like insurance policies, and in particular to hedged financial products having a guaranteed minimum withdrawal benefit (GMWB).

### BACKGROUND OF THE INVENTION

A GMWB is a relatively recent innovation in the variable annuity market. The GMWB promises a minimum payout level from an initial investment capital regardless of the performance of the assets in the separate account under the policy. More precisely, even when the value of the assets in the separate account (initial investment capital net of withdrawal and proportional insurance fees) of the policyholder falls to zero (or below) prior to the policy maturity date, the insurer continues to provide the guaranteed withdrawal amount until the specified maturity. If the account stays positive at maturity, the whole remaining balance in the account is paid to the policyholder at maturity. Thus, the total sum of cash flows received by the policyholder is guaranteed to be the same or above the original premium deposit.

Issuers of insurance policies, like insurance companies, offering GMWB riders are more commonly hedging the risks associated with providing such riders. This shift in insurer practices has been motivated by several factors. First, the economic risk of GMWBs are too significant to leave unhedged. Second, changes to Generally Accepted Accounting Principles (GAAP) accounting and statutory capital rules provide significant financial management incentives. Finally, rating agencies and market analysts look less favorably on insurers with significant exposure to stock market fluctuations.

Accordingly, there is a need for an effective and relatively simple method to hedge the risk associated with GMWBs offered as part of an insurance product.

### SUMMARY OF THE INVENTION

A method for generating a hedged financial product having a guaranteed minimum withdrawal benefit according to an exemplary embodiment of the present invention comprises the steps of: formulating a financial product having a guaranteed minimum withdrawal benefit which is defined by a payout calculated based on a function of an investment value of an underlying asset, the investment value being tied to a benchmark that changes based on a first algorithm; and hedging a risk associated with the guaranteed minimum withdrawal benefit by investing funds in one or more assets in accordance with a second algorithm which is a function of the first algorithm.

In at least one embodiment, the function of the investment value is a percentage of the investment value at a specified date.

In at least one embodiment, the specified date is a date of inception of the underlying asset.

In at least one embodiment, the specified date is an observation date of a high watermark of the investment value.

In at least one embodiment, the function of the investment value is an average of the investment value over a range of dates.

In at least one embodiment, the underlying asset comprises an account containing an insurance premium paid by an insurance policyholder.

In at least one embodiment, the insurance premium is received as a lump sum.

In at least one embodiment, the insurance premium is received as payments over time.

In at least one embodiment, the payout is triggered by the investment value reaching a high watermark.

In at least one embodiment, an output of the second algorithm is at least one of expected value of the payout and probability of paying the expected value.

In at least one embodiment, the one or more assets include one or more of the following: exchange traded financial products and over-the-counter financial products.

In at least one embodiment, the one or more assets include one or more of the following: stocks, exchange-traded funds (ETFs), fixed income securities, futures contracts on equities, future contracts on fixed income securities, forward contracts on equities, forward contracts on fixed income securities, option contracts on equities, and option contracts on fixed income securities.

In at least one embodiment, the second algorithm is selected from one of the following types of algorithms: Monte Carlo Simulation, Finite Difference Method, and Binomial/Trinomial Tree Method.

In at least one embodiment, the function which is a percentage is fixed.

In at least one embodiment, the payout comprises periodic payments.

In at least one embodiment, the payout is a lump sum payment.

In at least one embodiment, amount of the periodic payments depends on the specified date.

In at least one embodiment, number of periodic payments depends on the specified date.

In at least one embodiment, the financial product is an insurance product.

In at least one embodiment, the financial product is an exchange traded financial product or an over-the-counter financial product.

In at least one embodiment, the financial product is selected from one of the following types of financial products: stocks, funds, fixed income securities, futures contracts on equities, future contracts on fixed income securities, forward contracts on equities, forward contracts on fixed income securities, option contracts on equities, and option contracts on fixed income securities.

According to an exemplary embodiment of the present invention, a computer readable medium has instructions executable on a computer processor for performing a method for generating a hedged financial product having a guaranteed minimum withdrawal benefit, where the method comprises the steps of: formulating a financial product having a guaranteed minimum withdrawal benefit which is defined by a payout calculated based on a function of an investment value of an underlying asset, the investment value being tied to a benchmark that changes based on a first algorithm; and hedging a risk associated with the guaranteed minimum withdrawal benefit by investing funds in one or more assets in accordance with a second algorithm which is a function of the first algorithm.

A computer-based system for generating a hedged financial product having a guaranteed minimum withdrawal benefit according to an exemplary embodiment of the present invention comprises: a memory that stores data relating to the financial product; a computer-readable medium comprising: a financial product analyzer that generates a first set of instructions for tracking performance of an investment value that changes based on a first algorithm; a guaranteed minimum withdrawal benefit engine that generates a second set of instructions for determining the guaranteed minimum withdrawal benefit as defined by a payout calculated based on a function of the investment value as tracked by the financial product analyzer; a hedge investment analyzer that generates a third set of instructions for determining one or more assets in which to invest to hedge risk associated with the guaranteed minimum withdrawal benefit in accordance with a second algorithm which is a function of the first algorithm; and a hedging engine that generates a fourth set of instructions for investing funds in the one or more assets; and a processor that executes the first, second, third and fourth set of instructions.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a graph illustrating a GMWB rider on an insurance product according to an exemplary embodiment of the present invention;

FIG. 2 is a graph illustrating a high watermark calculation procedure used with an insurance product according to an exemplary embodiment of the present invention; and

FIG. 2 is a block diagram of a system for generating an insurance product having a GMWB according to an exemplary embodiment of the present invention.

### DETAILED DESCRIPTION OF PREFERRED EMBODIMENTS

Various exemplary embodiments of the present invention are directed to a system and method for generating a hedged financial product having a guaranteed minimum withdrawal benefit. Although the present disclosure is directed primarily to an insurance product, it should be appreciated that the concepts described herein may also be applied to other types of financial products, such as, for example, exchange traded financial products and over-the-counter financial products, and more particularly to stocks, funds, fixed income securities, futures contracts on equities, future contracts on fixed income securities, forward contracts on equities, forward contracts on fixed income securities, option contracts on equities, and option contracts on fixed income securities.

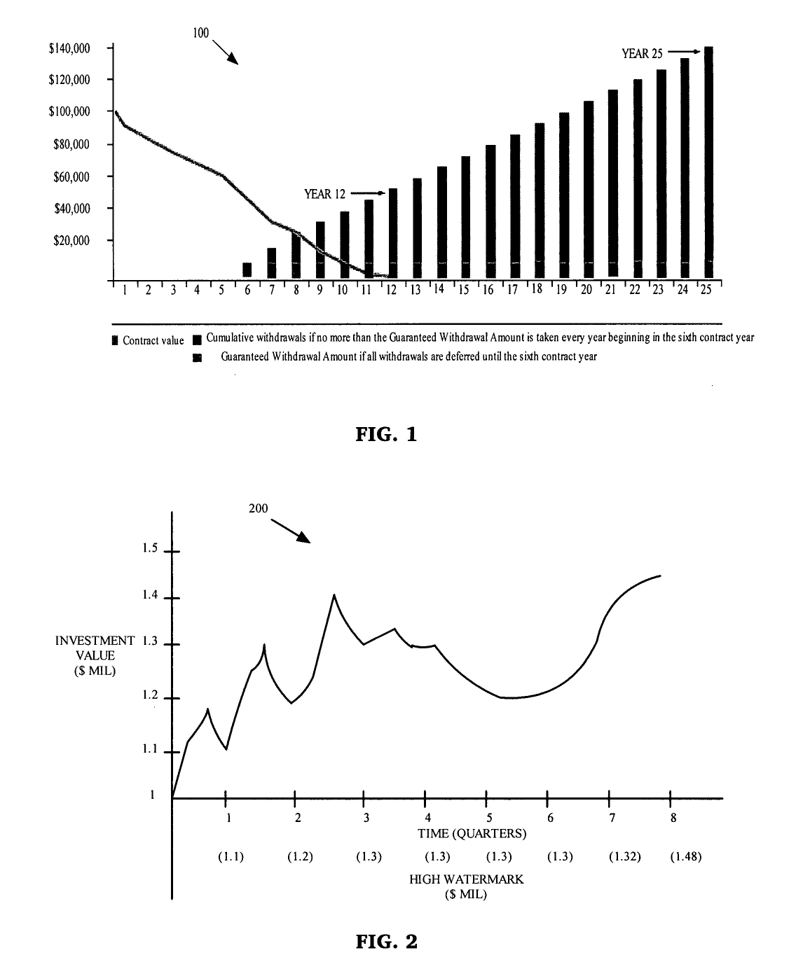

FIG. 1 shows a graph, generally designated by reference number 100, which illustrates the function of a GMWB rider on an insurance product according to an exemplary embodiment of the present invention. The hypothetical values depicted in the graph 100 are illustrative only and are not meant to limit the present invention to such values or range of values. The graph 100 shows the underlying investment value diminishing over time until it reaches a value of $0 at the end of the twelfth year. Thus, the “high watermark” of the investment value is the initial value of $100,000 at year 0. It should be appreciated that in other instances, the investment value may increase after the initial investment such that the high watermark is reached sometime after year 0. Additionally, there may be more than one high watermark in the case where the investment value increases and decreases over time.

The investment value may be based on the performance of the assets in a separate account under the policy. The separate account may be funded by, for example, an insurance premium paid by an insurance holder, in a lump sum or as variable or fixed payments over time. Investments may be made in any number and type of financial products, such as, for example, equities or equity-linked investments instruments, fixed income or fixed income linked investment instruments, foreign currency or foreign currency linked investment instruments, commodities or commodity linked instruments, inflation linked instruments, credit linked instruments, and any other kind of investments. Preferably, the investment value of the underlying asset is tied to a benchmark, such as, for example, an index value or basket (i.e., value of several indices). Thus, the investment value may be modeled based on an algorithm that defines the investment value.

The availability of guaranteed withdrawals may be triggered by one or more events, such as, for example, the investment value reaching a predetermined percentage of the high watermark. In the example shown in the graph 100, guaranteed withdrawals are made by the policyholder at year 6 since the investment value reached a predetermined percentage of the high watermark of $100,000. The value of the guaranteed withdrawals is preferably defined by a payout calculated based on a function of an investment value of an underlying asset. For example, the function may be a percentage of the high watermark of the investment value, where the percentage is fixed, or an average of the investment value over a range of dates. The individual payments on the payout are preferably periodic payments, for example, monthly or annual payments.

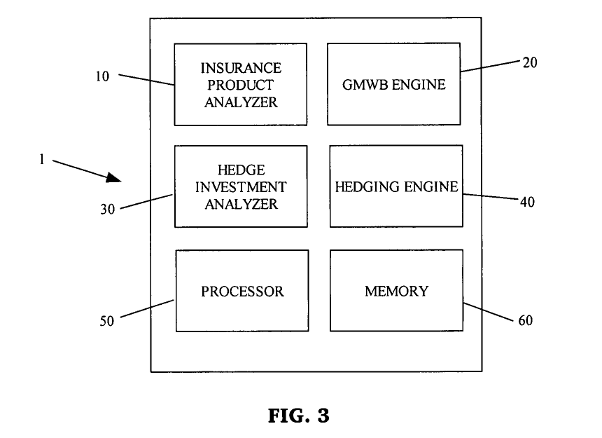

FIG. 2 shows a graph, generally designated by reference number 200, which illustrates a high watermark valuation procedure used with an insurance product according to another exemplary embodiment of the present invention. In this embodiment, there is no trigger mechanism. Periodic payments are made available on a recurring basis (in this example, on a yearly basis), with watermark valuation dates being set at quarterly dates. Thus, for example, at the fourth quarter of the first year, the high watermark is $1.3 million, since that is the highest value of the watermark as measured at the quarterly observation dates. Note that in this example, even though the watermark reached a higher level between quarters 2 and 3, this higher watermark level is ignored since it was not observed on one of the quarterly observation dates. Further, the valuation of the high watermark at the observation dates may take into account withdrawals made by the policyholder. In that case, the high watermark may be the actual high value of the underlying asset. Alternatively, the previous amounts withdrawn may be ignored in determining the value of the high watermark, in which case the high watermark is based on the hypothetical situation in which no withdrawals are made to reduce the value of the underlying asset.

In an exemplary embodiment of the present invention, the risk associated with the GMWB may be hedged by investing funds in one or more assets according to a second algorithm. The one or more assets may be, for example, exchange traded or over-the-counter financial products, stocks, funds, fixed income securities, futures contracts on equities, future contracts on fixed income securities, forward contracts on equities, forward contracts on fixed income securities, option contracts on equities, option contracts on fixed income securities, and other financial products.

Preferably, the second algorithm is a function of the algorithm used to model the benchmark tied to the investment value of the underlying asset. Further, the output of the second algorithm preferably includes the expected value of the payout and the probability of paying the expected value. Thus, for example, the insurer can use this information to determine the amount of funds to invest and the appropriate combination and types of investments to select so as to balance the risk associated with the GMWB. The second algorithm may be based on any suitable simulation techniques, such as, for example, Monte Carlo simulation, Finite Difference Method, Binomial/Trinomial Tree or some other numerical method.

FIG. 3 is a block diagram of a system, generally designated by reference number 1, of a system for generating a hedged insurance product having a guaranteed minimum withdrawal benefit according to an exemplary embodiment of the present invention. The system 1 includes an insurance product analyzer 10, a GMWB engine 20, a hedge investment analyzer 30, a hedging engine 40, a processor 50 and a memory element 60. The various components of the system 1 may be software components that generate instructions executed by the processor 50, hardware components, or a combination of hardware and software components.

The insurance product analyzer 10 tracks the performance of the investment value of the underlying asset and the associated high watermark. The GMWB engine 20 determines the GMWB as defined by a payout calculated based on a function of an investment value of an underlying asset, for example, as a percentage of the high watermark as tracked by the insurance product analyzer 10. The GMWB engine 20 may be triggered when the investment value of the underlying asset reaches a predetermined percentage of the high watermark.

The hedge investment analyzer 30 determines one or more assets in which to invest so as to hedge the GMWB. In this regard, the hedge investment analyzer 30 solves the second algorithm, which is a function of the algorithm used to model the investment value of the underlying asset. Thus, the hedge investment analyzer 30 preferably uses the expected value of the periodic payments and the probability of paying the expected value as an output of the second algorithm to determine the appropriate amounts of invested funds and types of investments.

The hedging engine 40 uses the investment information provided by the hedge investment analyzer 30 to invest funds in the appropriate investment products. In this regard, the hedging engine may track the performance of the investments to determine whether adjustments to the second algorithm need to be made in order to properly hedge the GMWB. Thus, the hedging engine 40 may provide feedback data to the hedge investment analyzer 30 that results in suitable adjustments to the hedge investments.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method for generating a hedged financial product having a guaranteed minimum withdrawal benefit comprising the steps of:
formulating a financial product having a guaranteed minimum withdrawal benefit which is defined by a payout calculated based on a function of an investment value of an underlying asset, the investment value being tied to a benchmark that changes based on a first algorithm; and
hedging a risk associated with the guaranteed minimum withdrawal benefit by investing funds in one or more assets in accordance with a second algorithm which is a function of the first algorithm.

2. The method of claim 1, wherein the function of the investment value is a percentage of the investment value at a specified date.

3. The method of claim 2, wherein the specified date is a date of inception of the underlying asset.

4. The method of claim 2, wherein the specified date is an observation date of a high watermark of the investment value.

5. The method of claim 1, wherein the function of the investment value is an average of the investment value over a range of dates.

6. The method claim 1, wherein the underlying asset comprises an account containing an insurance premium paid by an insurance policyholder.

7. The method of claim 6, wherein the insurance premium is received as a lump sum.

8. The method of claim 6, wherein the insurance premium is received as payments over time.

9. The method of claim 1, wherein the payout is triggered by the investment value reaching a high watermark.

10. The method of claim 1, wherein an output of the second algorithm is at least one of expected value of the payout and probability of paying the expected value.

11. The method of claim 1, wherein the one or more assets include one or more of the following: exchange traded financial products and over-the-counter financial products.

12. The method of claim 11, wherein the one or more assets include one or more of the following: stocks, funds, fixed income securities, futures contracts on equities, future contracts on fixed income securities, forward contracts on equities, forward contracts on fixed income securities, option contracts on equities, and option contracts on fixed income securities.

13. The method of claim 1, wherein the second algorithm is selected from one of the following types of algorithms: Monte Carlo Simulation, Finite Difference Method, and Binomial/Trinomial Tree Method.

14. The method of claim 2, wherein the function which is a percentage is fixed.

15. The method of claim 2, wherein the payout comprises periodic payments.

16. The method of claim 1, wherein the payout is a lump sum payment.

17. The method of claim 15, wherein an amount of the periodic payments depends on the specified date.

18. The method of claim 15, wherein a number of periodic payments depends on the specified date.

19. The method of claim 1, wherein the financial product is an insurance product.

20. The method of claim 1, wherein the financial product is an exchange traded financial product or an over-the-counter financial product.

21. The method of claim 20, wherein the financial product is selected from one of the following types of financial products: stocks, funds, fixed income securities, futures contracts on equities, future contracts on fixed income securities, forward contracts on equities, forward contracts on fixed income securities, option contracts on equities, and option contracts on fixed income securities.

22. A computer readable medium having instructions executable on a computer processor for performing a method for generating a hedged financial product having a guaranteed minimum withdrawal benefit, the method comprising the steps of:
formulating a financial product having a guaranteed minimum withdrawal benefit which is defined by a payout calculated based on a function of an investment value of an underlying asset, the investment value being tied to a benchmark that changes based on a first algorithm; and
hedging a risk associated with the guaranteed minimum withdrawal benefit by investing funds in one or more assets in accordance with a second algorithm which is a function of the first algorithm.

23. The computer readable medium of claim 22, wherein the financial product is an insurance product.

24. A computer-based system for generating a hedged financial product having a guaranteed minimum withdrawal benefit, comprising:
a memory that stores data relating to the financial product;
a computer-readable medium comprising:
a financial product analyzer that generates a first set of instructions for tracking performance of an investment value that changes based on a first algorithm;
a guaranteed minimum withdrawal benefit engine that generates a second set of instructions for determining the guaranteed minimum withdrawal benefit as defined by a payout calculated based on a function of the investment value as tracked by the financial product analyzer;
a hedge investment analyzer that generates a third set of instructions for determining one or more assets in which to invest to hedge risk associated with the guaranteed minimum withdrawal benefit in accordance with a second algorithm which is a function of the first algorithm; and
a hedging engine that generates a fourth set of instructions for investing funds in the one or more assets; and
a processor that executes the first, second, third and fourth set of instructions.

25. The computer-based system of claim 24, wherein the financial product is an insurance product.
